(19) United States
(12) Patent Application Publication
(10) Pub. No.: US 2008/0193348 A1
(43) Pub. Date: Aug. 14, 2008

(54) Liquid Transport Member

(76) Inventors: Ayumi Kooriyama, Sagamihar (JP); Hiroshi Shimada, Tokyo (JP)

Correspondence Address: 3M INNOVATIVE PROPERTIES COMPANY, PO BOX 33427, ST. PAUL, MN, 55133-3427, US

(21) Appl. No.: 11/914,307

(22) PCT Filed: May 22, 2006
(86) PCT No.: PCT/US06/19704

§ 371 Date: Nov. 13, 2007

(30) Foreign Application Priority Data
May 24, 2005 (JP) 2005-150828

(51) Int. Cl. B01J 19/00

(52) U.S. Cl. 422/211

(57) ABSTRACT

The present invention provides an improved liquid transport member that maintains high transport characteristics with respect to highly polar liquids in particular not only during initial use but also in usage environments. This liquid transport member includes a base material having a plurality of grooves formed in a predetermined pattern in the surface, and a plurality of photocatalyst particles arranged on the surface of the grooves.

### BACKGROUND

The present invention relates to a liquid transport member that transports a liquid by controlling the direction of liquid flow.

Liquid transport members are useful for transporting various liquids such as blood, body fluids, urine, alcohol, water and ink, and these liquid transport members are known to be used for surgical, dental, specimen testing and medical applications, as well as for food trays, diapers and ink jet printer heads (see, for example, Japanese Unexamined International Patent Publication No. 2002-535039 and Japanese Unexamined International Patent Publication No. 2002-518103).

This liquid transport member is provided with a plurality of grooves capable of spontaneously transporting a liquid in the direction in which they extend, and the liquid is transported from a certain site to a different site along the grooves by capillary action. In the case of liquid transport members of the prior art, materials were used consisting primarily of blending a surfactant into polyethylene. Polyethylene is useful as a material for liquid transport members because of its superior chemical resistance and moisture resistance, low cost, flexibility and high processability. In addition, surfactants have the action of increasing the surface energy for transporting highly polar liquids in particular on the surface of polyethylene film.

The main characteristics required of liquid transport members consist of an initial high liquid transport capacity, and the maintaining of that transport capacity in usage or storage environments. In contrast, in the case of liquid transport members of the prior art produced from materials incorporating surfactant, although the desired liquid transport characteristics are obtained initially, during the course of continuous use and in applications in which the member makes continuous contact with a liquid, a decrease in transport characteristics is observed particularly in the case of highly polar liquids. The reason for this is that since the surfactant is merely mixed in and does not form rigid bonds (e.g., covalent bonds) with the polyethylene base material, during the course of continuous use and in applications in which there is continuous contact with liquid, the surfactant gradually transfers into the liquid.

In addition, long-term use with highly polar liquids as described above cannot be expected in cases in which contaminants become adhered during storage or use of this liquid transport member. This is because the hydrophilicity of the surface of the liquid transport member decreases due to the presence of such contaminants, thereby causing a decrease in the liquid transport capacity. Although this contamination can be removed to a certain extent by mechanical and/or chemical washing using running water or a sponge and so forth, since the transfer of the surfactant from the surface of the base material is accelerated by this washing, hydrophilicity ends up decreasing considerably.

Moreover, in the case where contaminants having a comparatively small size enter the grooves or in the case of highly viscous contaminants, they are difficult to remove even by the aforementioned mechanical and/or chemical washing. As a result, contaminants accumulate in the liquid transport member in a comparatively short period of time, thereby causing the liquid transport member to lose its liquid transport capacity.

Methods are disclosed to solve these problems in Japanese Unexamined International Patent Publication No. 2002-535039 consisting of increasing the amount of surfactant and using a surfactant having multifunctional alkoxy groups and then immobilizing by curing with moisture. However, the former method does not offer a substantial solution to the aforementioned problems, while in the latter method, the technique used to confirm completion of the reaction is limited due to the difficulty in controlling moisture curing.

### SUMMARY

The present invention provides a liquid transport member that maintains high transport characteristics over a long period of time, particularly with respect to highly polar liquids, not only initially but also in the usage environment.

In order to achieve the aforementioned, the present invention provides a liquid transport member provided with: a base material having a plurality of grooves formed in a predetermined pattern in the surface, and a plurality of photocatalyst particles arranged on the surface of the grooves.

Since a liquid transport member of the present invention has a plurality of photocatalyst particles arranged on the surface of a plurality of grooves formed in a predetermined pattern provided in the surface of a base material, it is able to maintain a high liquid transport capacity as a result of having high hydrophilicity and preventing contamination even during long-term use.

### BRIEF DESCRIPTION OF THE DRAWINGS

FIG. 1 is a cross-sectional view showing one aspect of the shape of grooves on a liquid transport member of the present invention.

FIG. 2 is a cross-sectional view showing one aspect of the shape of grooves on a liquid transport member of the present invention.

FIG. 3 is a cross-sectional view showing one aspect of the shape of grooves on a liquid transport member of the present invention.

FIG. 4 is a cross-sectional view showing the form of a liquid transport member produced in an embodiment.

FIG. 5 is a graph showing the results of a weather resistance test.

FIG. 6 is a graph showing the results of an underwater exposure test.

### DETAILED DESCRIPTION

A liquid transport member of the present invention is provided with a plurality of grooves formed in a predetermined pattern in the surface of a base material, and a plurality of photocatalyst particles are arranged in the surface of these grooves. The base material is preferably composed of a polyolefin. Since polyolefins have high levels of chemical and moisture resistance, are inexpensive, flexible and have superior processability, they are preferably used as the base material of liquid transport members. Examples of polyolefins include polyethylene, polypropylene, propylene-ethylene copolymer, polybutene and polymethylpentene-1.

Polyethylene is particularly preferable since it allows the obtaining of adequate mechanical strength for the grooves formed in the surface, and is imparted with heat resistance by an internal crosslinking reaction. These polyolefins may be copolymerized with hydrophilic monomers containing carboxyl groups, hydroxyl groups or amino groups and so forth, or with acrylic esters, during ethylene, propylene or other monomer polymerization to improve flexibility and adhesion within a range that does not have an effect on the characteristics of the liquid transport member. Moreover, antioxidants, various types of stabilizers, processing assistants, lubricants, pigments, intensifiers for increasing internal crosslinking and other low molecular weight compounds may also be contained. The amounts of these low molecular weight compounds should be held to a minimum in consideration of usage environment of the liquid transport member and the production process of this liquid transport member that uses radicals.

In addition, a ceramic material can be used for the base material of the liquid transport member of the present invention. Ceramics are preferable because they have a high degree of hardness, have superior wear resistance, scratch resistance, weather resistance, heat resistance and insulating properties, do not swell in the presence of chemicals or water, and are inexpensive. There are no particular restrictions on this ceramic material, and examples of ceramic materials that can be used include all types of naturally-occurring and artificial ceramics and glass that are used as structural materials. Specific examples include alkaline-containing glass such as soda lime glass and soda potash glass, low softening point glass such as lead glass and bismuth glass, and high-purity silica glass such as quartz glass, as well as simple oxide ceramics such as magnesia, calcia and alumina, multi-component ceramics such as mullite and cordierite, and non-oxide-based ceramics such as silicon nitride, silicon carbide and boron carbide. In addition, another example is ceramic-glass composites such as crystallized glass.

Further, a metal can be used for the base material of the liquid transport member of the present invention. Examples of metals that can be used include iron, aluminium, alumina, nickel, titanium, copper, and alloy thereof (for example, stainless steel).

The plurality of grooves formed in a predetermined pattern in this base material are formed by a common molding method such as embossing. The grooves may be of any shape provided they are able to transport liquid along the axial direction of the grooves. For example, the shape of the grooves may be a V-shape, rectangular or combination thereof, and they have a shape in which second grooves are contained within first grooves. In addition, the grooves may be in any pattern provided the pattern used enables liquid to be transported along the direction in which the grooves extend, and a pattern may be employed in which, for example, the grooves extend mutually in parallel at fixed intervals. In addition, a pattern may be employed in which the grooves extend in the form of radiating lines.

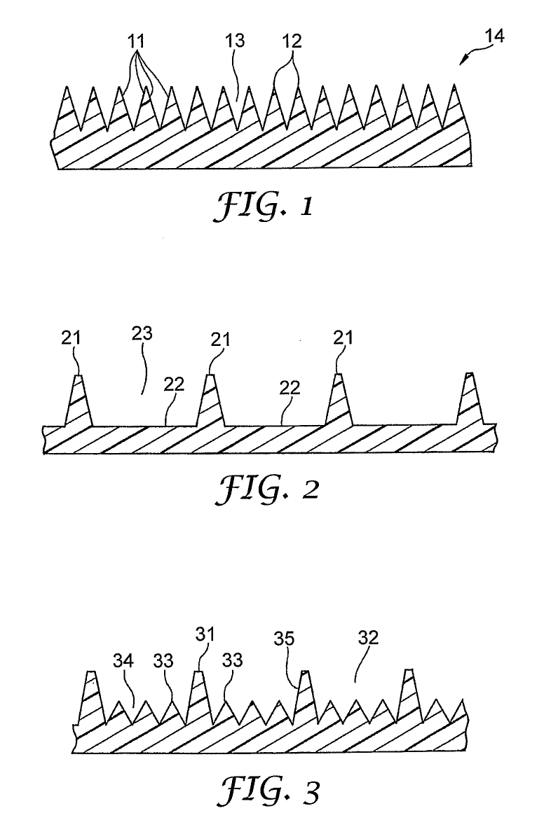

The following provides an explanation of the shape of the grooves with reference to the drawings. As shown in FIG. 1, grooves 13 can be formed on base material 14 by a series of V-shaped side walls 11 and tips 12. In addition, as shown in FIG. 2, grooves 23 may be formed by providing wide, flat trough sections 22 between slightly flattened tips 21. The depth of the grooves (namely, the distance from the tips to the trough sections) is typically 5 to 3000 μm, and preferably 80 to 1000 μm.

In FIG. 3, wide first grooves 32 are formed between tips 31, and instead of providing a flat surface between side walls 35 of these first grooves 32, a plurality of low tips 33 are provided between tips 31, and second grooves 34 are formed between these low tips 33.

In grooves formed in this manner, the maximum width of the first grooves 32 is typically less than 3000 μm, and preferably less than 1500 μm. In addition, the depth of the first grooves 32 is typically 30 to 3000 μm, and preferably 80 to 1000 μm. In addition, the depth of the second grooves is preferably 5 to 50% of the depth of the first grooves. The shape of the grooves may be any shape other than the shapes indicated in FIGS. 1 to 3, and the width of the grooves may be changed along the direction in which they extend. Moreover, the side walls of the grooves do not have to be linear, but may also be curved in the direction in which they extend.

In a liquid transport member of the present invention, a plurality of photocatalyst particles are arranged in the surface of the aforementioned grooves, and the surface is hydrophilic. This “hydrophilicity” refers to having a contact angle of less than 90° and preferably about 0°. Examples of photocatalyst particles include one type or a mixture of two or more types selected from the group consisting of titanium dioxide (anatase titanium oxide, Brookite titanium oxide, rutile titanium oxide), tin oxide, zinc oxide, dibismuth trioxide, tungsten trioxide, ferric oxide and strontium titanate. The particle diameter of these photocatalyst particles is preferably from several nanometers to several micrometers.

In order to immobilize the photocatalyst particles on the surface of the grooves on the base material, a solution in which the photocatalyst particles are dispersed in water or solvent is coated on the surface of the grooves by spray coating, dip coating, spin coating or sputtering and so forth, and in the case the base material is made of ceramics, are immobilized to form a coating layer by baking. In the case the base material is made of a metal, the photocatalyst particles are immobilized by coating, depositing, or thermal spraying the photocatalyst particles on the surface of the metal. In the case where the base material is made of titanium, a photocatalyst is formed by calcining the titanium to oxidate the titanium. Alternatively, the photocatalyst particles are mixed with the material that composes the base material and the immobilized by molding into a predetermined shape. In the case of immobilizing the photocatalyst particles in the form of a coating layer, the thickness of the photocatalyst particle layer is preferably that which does not cause a change in the microstructure provided on the base material intended to demonstrate capillary action, and although the preferable thickness varies according to the shape of the grooves, it is normally 0.01 to 5 μm and preferably 0.05 to 1 μm.

In the case where the base material is made from an organic material, in order to prevent deterioration of the base material itself due to photocatalysis and improve adhesion between the base material and photocatalyst particles, it is preferable to either adhere the photocatalyst particles and base material by interposing an adhesive layer between them, or by processing the surface of the photocatalyst particles and mixing them into the base material. For example, a part of the surface of the photocatalyst particle is coated with a ceramic, or an inorganic layer is inserted between the base material and the photocatalyst layer in order to prevent a direct contact of the base material and the photocatalyst particles.

Photocatalysis is known to involve the occurrence of two types of superior phenomena consisting of ultra-hydrophilicity and oxidative degradation resulting from the absorbance of ultraviolet light from sunlight or interior light. Since water droplets form a film and spread over the surface of the grooves even if they adhere to the surface due to the effect of ultra-hydrophilicity, it is effective for preventing clouding and preventing adhesion of contaminants, while oxidative degradation removes and deodorizes organic contaminants and imparts antimicrobial effects.

As has been described above, as a result of arranging photocatalyst particles on the surface of grooves of a liquid transport member, the ultra-hydrophilicity of the photocatalyst is remarkably effective in transporting highly polar liquids in particular in a short period of time. Here, although liquid transport capacity refers to the amount of time during which a liquid is transported over the grooves for a fixed distance, liquid transport capacity and surface hydrophilicity are in an extremely intimate relationship, with liquid transport capacity increasing the higher the degree of hydrophilicity. As has been described above, as a result of arranging photocatalyst particles on the surface of the grooves, the contact angle becomes roughly 0°, thereby making it possible to expect an improvement in liquid transport capacity.

In addition, the oxidative degradation of the photocatalyst makes it possible to degrade contaminants that have adhered to the surface of the grooves or have penetrated deep into the grooves. As a result, the surface of the base material is kept in a clean state at all times, thereby making it possible to maintain a hydrophilic state and maintain a high liquid transport capacity in usage environments. Moreover, the growth of mold and so forth can be prevented even when used for long periods of time in usage environments due to the antimicrobial effects accompanying oxidative degradation.

As has been described above, since a liquid transport member of the present invention has a high liquid transport capacity both initially and in usage environments with respect to highly polar liquids, it is particularly effective in applications in which a liquid is transported continuously or in applications in which a liquid is continuously transported repeatedly. In the case of using a polyolefin for the base material, the transport member can be formed into the shape of a film. In the case a liquid transport member of the present invention uses a ceramic material for the base material, it has superior wear resistance, scratch resistance, weather resistance and heat resistance, and can be formed into the shape of construction materials such as bathroom or kitchen tiles, exterior wall materials, billboards and window moisture condensation prevention moldings.

In addition, a liquid transport member of the present invention is also effectively used as a construction material for alleviating heat island phenomenon. This heat island phenomenon is a phenomenon that causes the temperature to rise in urban areas, and is caused by such factors as decreased vegetation, increased levels of exhaust gases and increased waste heat accompanying increased energy consumption. Although energy conservation measures and measures for protecting vegetation and waterfronts have been adopted in order to counter this heat island phenomenon, attempts have been made to alleviate this heat island phenomenon by inhibiting rises in the ambient atmospheric temperature by forming water films by allowing accumulated rainwater and so forth to flow over the exterior wall surfaces of buildings and factories to utilize the latent heat required when that water is evaporated, while simultaneously insulating buildings and factories and inhibiting energy consumption by increasing the efficiency of air-conditioning systems. In order to minimize the amount of water used and prevent splashing of the water droplets when attempting to form a water film with rainwater and so forth on the exterior wall surfaces of buildings and factories in this manner, the surfaces are preferably hydrophilic, and it is necessary that the adhesion of moss and algae to the exterior wall surfaces, for which there is the risk of growth due to the flowing rainwater and so forth, be prevented.

As a result of using a liquid transport member of the present invention as an exterior wall material of a building, the surface can be made to be ultra-hydrophilic, which together with making it possible form an ideal water film, also enables the prevention of adhesion of moss and algae to the exterior wall surfaces by a photocatalytic reaction. Moreover, since a liquid transport member of the present invention has a plurality of grooves formed in its surface, water droplets that have fallen onto the surface can be made to spread out in the horizontal direction, namely the direction parallel to the ground, as a result of installing a liquid transport member in which the grooves are parallel to the ground. In addition, since even a small amount of water spreads out effectively over the surface, a water film can be formed efficiently.

### EXAMPLES

The following provides an additional explanation of the present invention.

### Example 1

A film having the form shown in FIG. 4 was produced by injection molding at 125° C. using polyethylene (Petrosen 208, Tosoh) for the casting mold. Furthermore, the dimensions of this film are shown in Table 1. The overall thickness of this film was 300 to 1000 μm. A photocatalyst spray (K-20, Kawasaki Heavy Industries) was coated on the surfaces formed by the grooves of this film followed by drying for 30 minutes at room temperature. The film was then irradiated with ultraviolet light for 24 hours using a 313 nm weather meter.

### Example 2

A catalyst (CE621, GE Toshiba Silicones) was added to a silicone resin (TSE3502, GE Toshiba Silicones) to a concentration of 0.5% by weight of the resin. This was coated onto the surfaces formed by grooves in a conventional polyethylene liquid transport film and cured for at least a half day at room temperature followed by removing from the film to produce a silicone mold.

Separate from the above, 90 g of a photocurable resin (comprising a 35:15:50 mixture of Epoxy Ester 3000M (Kyoei Chemical), triethylene glycol methacrylate (Wako Pure Chemical Industries) and 1,3-butanediol (Wako Pure Chemical Industries), 0.2 g of an initiator (Irgacure 819, Ciba-Geigy Japan), 1.8 g of surfactant (POCA (phosphate propoxyl alkyl polyole), 3M), 1.8 g of Neopelex No. 25 (sulfonic acid-based surfactant, Kao) and 270 g of glass powder (YFT065, Asahi Glass) were mixed to produce a glass paste. This glass paste was placed on the ends of a glass plate, and the aforementioned silicone mold was laminated onto the glass plate using a rubber roller. At this time, lamination was carried out so that the direction of lamination was parallel to the direction of the grooves of the silicone mold. Subsequently, the laminate was irradiated for 30 seconds with light having a wavelength of 400 to 500 nm using a Philips fluorescent lamp to cure the glass paste followed by removal of the silicone mold. When the formed surfaces of the grooves produced in this manner were observed with an electron microscope, fine grooves were observed to be extending in a single direction. The dimensions of the grooves are shown in Table 1.

Next, a photocatalyst spray (K-20, Kawasaki Heavy Industries) was coated on the surfaces formed by the grooves followed by drying for 30 minutes at room temperature. This was then irradiated for 24 hours with ultraviolet light using a 313 nm weather meter.

### Comparative Example 1

A nonionic surfactant (Triton X-35, Rohm & Haas) was melted and sprayed onto polyethylene (Tenite 18BOA, Eastman) to a concentration of 1% by weight to produce a film having the form shown in FIG. 4 (dimensions are shown in Table 1) having an overall thickness of 200 to 300 μm.

TABLE 1
Table 1 Dimensions of Each Part (μm)

| | (1) | (2) | (3) | (4) |
|---|---|---|---|---|
| Ex. 1 | 220 | 50 | 100 | 30 |
| Ex. 2 | 219 | 47.5 | 61.6 | 17.8 |
| Comp. Ex. 1 | 220 | 50 | 100 | 30 |

Evaluation of Liquid Transport Characteristics

The aforementioned liquid transport members were placed horizontally with the surfaces containing grooves facing up, and 2 mL of distilled water were dropped thereon using a dropper from a height of about 10 mm from the surface. The times until the water reached a location of 50 mm and 100 mm in the direction of the grooves were then measured defining the location where the water was dropped as the starting point (initial test). Those results are shown in Table 2.

TABLE 2

| | Time until water | Time until water |
|---|---|---|
| | reached 50 mm | reached 100 mm |
| | (seconds) | (seconds) |
| Example 1 | 4.2 | 25.8 |
| Example 2 | 2.3 | 13.8 |
| Comparative Example 1 | 5.8 | 26.0 |

Weather Resistance

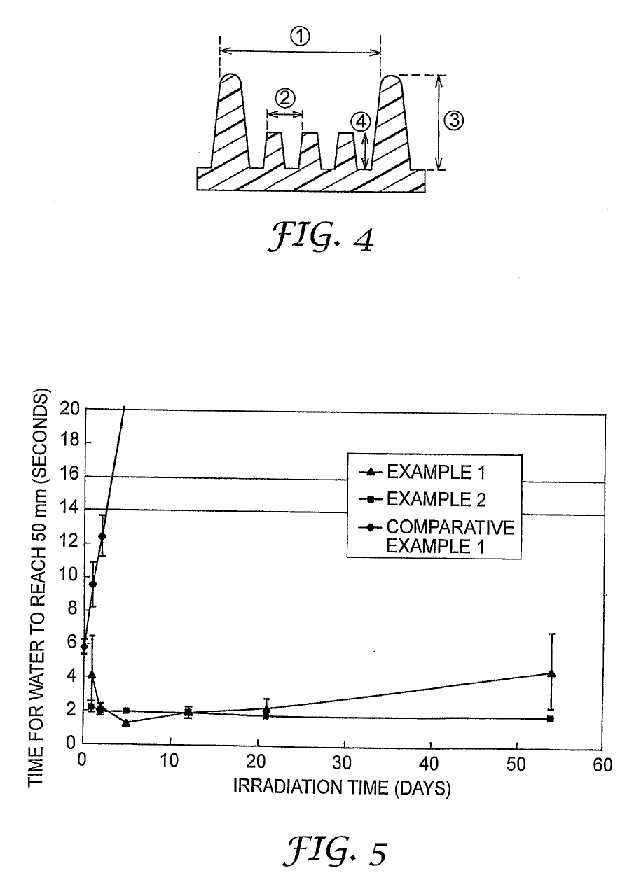

Following completion of the initial test, the dried liquid transport members were again irradiated with ultraviolet light using a 313 nm weather meter. Subsequently, a transport test was carried out in the same manner as the initial test after which a fixed period of irradiation and the transport test were repeated. Those results are shown in FIG. 5.

Underwater Exposure Test

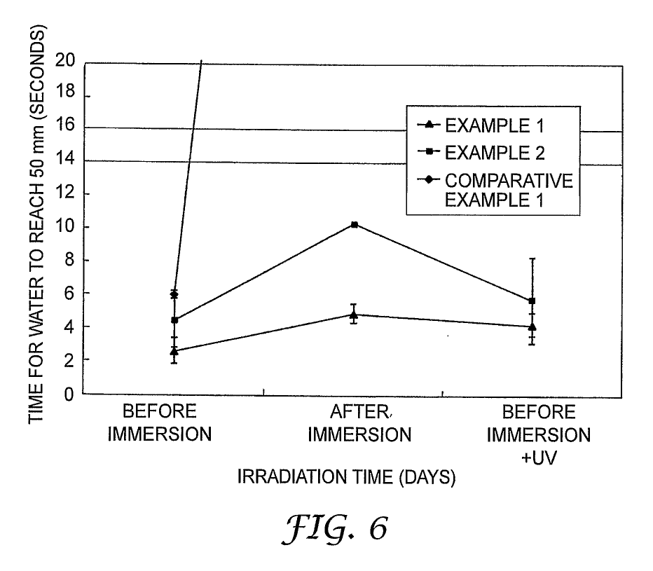

Following completion of the initial test, the dried liquid transport members were immersed in ion exchange water and removed after 17 days. After drying, a transport test was carried out in the same manner as the initial test. Those results are shown in FIG. 6.

Liquid transport members of the present invention in which photocatalyst particles were arranged on the surfaces produced in Embodiments 1 and 2 demonstrated initial liquid transport characteristics that were equal to or better than a liquid transport member of the prior art containing surfactant (Comparative Example 1), and demonstrated a rapid transport rate. This is the result of the high degree of wettability of the surface hydrophilized by photocatalyst.

In addition, in the weather resistance test, in contrast to the surface nearly completely losing hydrophilicity 12 days after being irradiated with ultraviolet light in Comparative Example 1, Embodiments 1 and 2 demonstrated high transport characteristics even after 50 days had elapsed. In Embodiment 2 that used a ceramic material in particular, a high transport capacity equal to that of initial transport capacity was maintained even after 50 days.

Moreover, Embodiments 1 and 2 maintained high transport characteristics as compared with Comparative Example 1 in the underwater exposure test as well. This is due to photocatalyst being immobilized on the surface in Embodiments 1 and 2 resulting in superior durability in contrast to the surfactant ending up transferring into the water in Comparative Example 1.

What is claimed is:

1. A liquid transport member comprising:
a base material having a plurality of grooves formed in a predetermined pattern in the surface, and
a plurality of photocatalyst particles arranged on the surface of the grooves.

2. The liquid transport member according to claim 1 wherein the base material is made of a polyolefin.

3. The liquid transport member according to claim 1 wherein the base material is made of a ceramic material.

4. The liquid transport member according to claim 2 wherein the polyolefin is polyethylene.

5. The liquid transport member according to claim 1 wherein the base material is made of a metal.

6. The liquid transport member according to claim 1 wherein the depth of the grooves is 5 to 3000 μm.

7. The liquid transport member according to claim 1 wherein the grooves have first grooves and second grooves formed within the first grooves, the depth of the first grooves is 30 to 3000 μm, and the depth of the second grooves is 5 to 50% the depth of the first grooves.

8. The liquid transport member according to claim 1 wherein the photocatalyst particles are one type or a mixture of two or more types selected from the group consisting of titanium dioxide, tin oxide, zinc oxide, dibismuth trioxide, tungsten trioxide, ferric oxide and strontium titanate.

9. The liquid transport member according to claim 1 wherein the predetermined pattern of the grooves extends mutually in parallel at a fixed interval.

10. The liquid transport member according to claim 1 wherein the photocatalyst particles are immobilized by arranging in a coating layer on the surface of the grooves.

11. The liquid transport member according to claim 1 wherein the photocatalyst particles are fixed by mixing in the base material.
